(19) United States
(12) Patent Application Publication
(10) Pub. No.: US 2014/0168158 A1
(43) Pub. Date: Jun. 19, 2014

(54) Touch Panel Structure of Narrow Border

(71) Applicant: SuperC-Touch Corporation, New Taipei City (TW)

(72) Inventor: Hsiang-Yu LEE, New Taipei City (TW)

(73) Assignee: SuperC-Touch Corporation, New Taipei City (TW)

(21) Appl. No.: 14/108,189

(22) Filed: Dec. 16, 2013

(30) Foreign Application Priority Data
Dec. 18, 2012 (TW) 101224493

(51) Int. Cl. G06F 3/044

(52) U.S. Cl. CPC G06F 3/044
USPC 345/174

(57) ABSTRACT

A touch panel structure of narrow border includes a panel having an inner surface, a first sensing electrode layer and a second sensing electrode layer formed on the inner surface. The first sensing electrode layer includes plural first conductor line units and plural connection lines arranged in a first direction for detecting whether there is an external object approached according to a touch driving signal. The second sensing electrode layer includes plural second conductor line units arranged in a second direction. When performing a touch sensing and receiving the touch driving signal, each of the second conductor line units makes use of a corresponding connection line to be extended to one side of the panel.

### BACKGROUND OF THE INVENTION

1. Field of the Invention

The present invention relates to the technical field of touch panels and, more particularly, to a touch panel structure of narrow border.

2. Description of Related Art

Modern consumer electronic apparatuses are typically equipped with touch panels for use as their input devices. According to different sensing manners, the touch panels can be classified into resistive type, capacitive type, acoustic type, and optical type.

The principle of touch panels is based on different sensing manners to detect a voltage, current, acoustic wave, or infrared to thereby detect the coordinates of touch points on a screen where a finger or other medium touches. For example, a resistive touch panel uses a potential difference between the upper and lower electrodes to compute the position of a pressed point for detecting the location of the touch point, and a capacitive touch panel uses a capacitance change generated in an electrostatic combination of the arranged transparent electrodes with a human body to generate a current or voltage for detecting touch coordinates.

With the widespread use of smart phones, the multi-touch technique is getting more and more important. Currently, the multi-touch is implemented by projected capacitive touch technique.

The projected capacitive touch technique makes use of two layers of indium tin oxide (ITO) to form a matrix of sensing units arranged in intersected columns and rows, so as to detect precise touch positions. The projected capacitive touch technique is based on capacitive sensing, wherein it designs plural etched ITO electrodes and adds plural sets of transparent conductor lines that are on different planes and vertical with each other to form X-axis and Y-axis driving lines. These conductor lines are all controlled by a controller for being sequentially scanned to detect capacitance changes that are sent to the controller.

However, the cost of ITO is high and, due to the optical characteristic of ITO, light penetration rate is decreased and the reflection rate is increased, resulting in higher power consumption, which is disadvantageous in developing the touch panels and increases the production cost.

Therefore, it is desirable to provide an improved touch panel device to mitigate and/or obviate the aforementioned problems.

### SUMMARY OF THE INVENTION

The object of the present invention is to provide a touch panel structure of narrow border, which can significantly increase the sensing signal strength and the light penetrability of a touch panel and also can greatly save the material cost and the manufacturing cost, and which is suitable for narrow border design in comparison with the prior art.

To achieve the object, there is provided a touch panel structure of narrow border, which comprises: a panel having an inner surface; a first sensing electrode layer formed on the inner surface and including M first conductor line units and N connection lines arranged in a first direction for detecting whether there is an external object approached according to a touch driving signal, where M and N are each a positive integer; and a second sensing electrode layer formed on the inner surface and includes N second conductor line units arranged in a second direction, wherein, when performing a touch sensing and receiving the touch driving signal, each of the N second conductor line units makes use of a corresponding i-th connection line to be extended to one side of the panel, where i is an integer and 1≦i≦N .

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of a touch panel structure of narrow border according to an embodiment of the invention;

FIG. 2 is schematic diagram of a touch panel structure of narrow border according to another embodiment of the invention;

FIG. 3 is a schematic diagram of a first conductor line unit; and

FIG. 4 is a schematic diagram of a prior touch panel structure.

### DETAILED DESCRIPTION OF THE PREFERRED EMBODIMENT

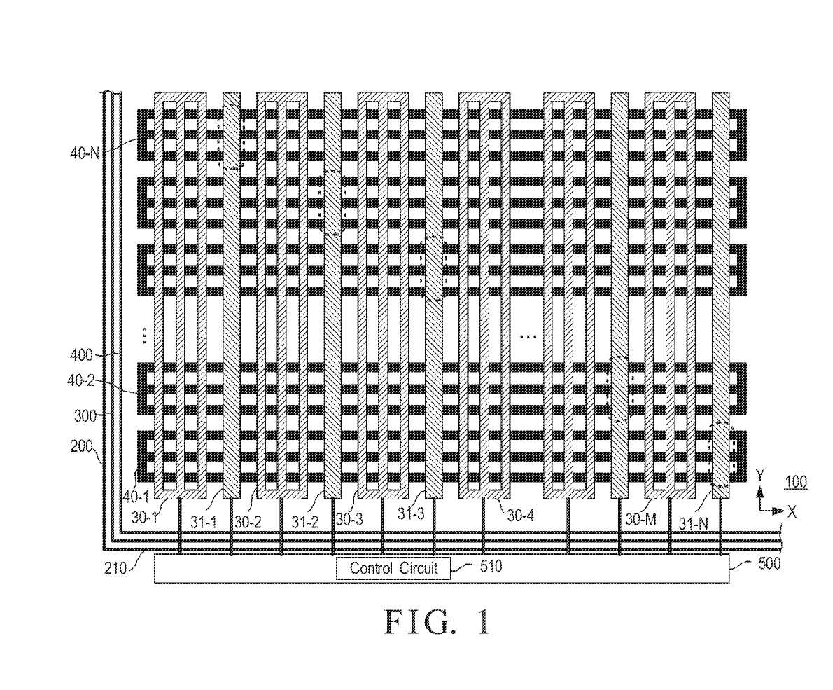

FIG. 1 is a schematic diagram of a touch panel structure of narrow border 100 according to an embodiment of the invention. The touch panel structure of narrow border 100 includes a panel 200, a first sensing electrode layer 300 and a second sensing electrode layer 400.

The panel 200 has an inner surface (not shown). The first sensing electrode layer 300 is formed on the inner surface and includes M first conductor line units 30-1, 30-2, . . . , 30-M and N connection lines 31-1, 31-2, . . . , 31-M arranged in a first direction (Y-direction) for detecting whether there is an external object approached, where M and N are each a positive integer. The N connection lines 31-1, 31-2, . . . , 31-N are made of conductive metal material.

The second sensing electrode layer 400 is formed on the inner surface and includes N second conductor line units 40-1, 40-2, . . . , 40-N arranged in a second direction (X-direction). When performing touch sensing and receiving touch driving signals, each of the N second conductor line units 40-1, 40-2, . . . , 40-N makes use of a corresponding i-th connection line (31-1, 31-2, . . . , 31-M) to be extended to one side 210 of the panel 200, where i is an integer and 1≦i≦N. The first direction is substantially vertical with the second direction.

As shown in FIG. 1, each of the M first conductor line units 30-1, 30-2, . . . , 30-M is composed of plural metal sensing lines, for example three metal sensing lines in this embodiment, and each of the N second conductor line units 40-1, 40-2, . . . , 40-N is composed of plural metal sensing lines, for example three metal sensing lines in this embodiment. The M first conductor line units 30-1, 30-2, . . . , 30-M and the N second conductor line units 40-1, 40-2, . . . , 40-N are not electrically connected with each other. Preferably, an insulation layer may be arranged between the first sensing electrode layer 300 and the second sensing electrode layer 400. Alternatively, it is also applicable to arranged insulation traces or insulation blocks in-between the intersections of the M first conductor line units 30-1, 30-2, . . . , 30-M and the N second conductor line units 40-1, 40-2, . . . , 40-N.

The plural metal sensing lines of each of the M first conductor line units 30-1, 30-2, . . . , 30-M form a quadrilateral region, and the plural metal sensing lines of each of the N second conductor line units 40-1, 40-2, . . . , 40-N also form a quadrilateral region. The metal sensing lines in each quadrilateral region are electrically connected together, while any two of the quadrilateral regions are not connected with each other. The quadrilateral region has a shape of rectangle or square.

Each of the N connection lines 31-1, 31-2, . . . , 31-N is disposed between two first conductor line units (30-1, 30-2, . . . , 30-M).

The metal sensing lines in each quadrilateral region formed by the plural metal sensing lines of each of the M first conductor line units 30-1, 30-2, . . . , 30-M and the N second conductor line units 40-1, 40-2, . . . , 40-N are made of conductive metal material or alloy material. The conductive metal material is selectively to be chromium, barium, aluminum, silver, copper, titanium, nickel, tantalum, cobalt, tungsten, or their alloy or silicide.

As shown in FIG. 1, each of the N second conductor line units 40-1, 40-2, . . . , 40-N is electrically connected with a corresponding connection line (31-1, 31-2, . . . , 31-N) at a position denoted by a dotted ellipse, and each of the N connection lines 31-1, 31-2, . . . , 31-N is extended to the same side 210 of the panel 200 through a corresponding metal wire for being further connected to the flexible circuit board 500. Each of the M first conductor line units 30-1, 30-2, . . . , 30-M is extended to the same side 210 of the panel 200 through a corresponding metal wire for being further connected to the flexible circuit board 500.

The surface of the panel 200 is provided to receive at least one touch point. There is further provided with a control circuit 510 which is electrically connected to the M first conductor line units 30-1, 30-2, . . . , 30-M and the N second conductor line units 40-1, 40-2, . . . , 40-N via the flexible circuit board 500.

The M first conductor line units 30-1, 30-2, . . . , 30-M and the N second conductor line units 40-1, 40-2, . . . , 40-N correspondingly generate a sensing signal in response to the position and magnitude of a finger's touch on at least one touch point of the panel 200. The control circuit 510 is electrically connected to the M first conductor line units 30-1, 30-2, . . . , 30-M and the N second conductor line units 40-1, 40-2, . . . , 40-N via the flexible circuit board 500, so as to calculate the coordinate of the at least one touch point based on the sensing signal.

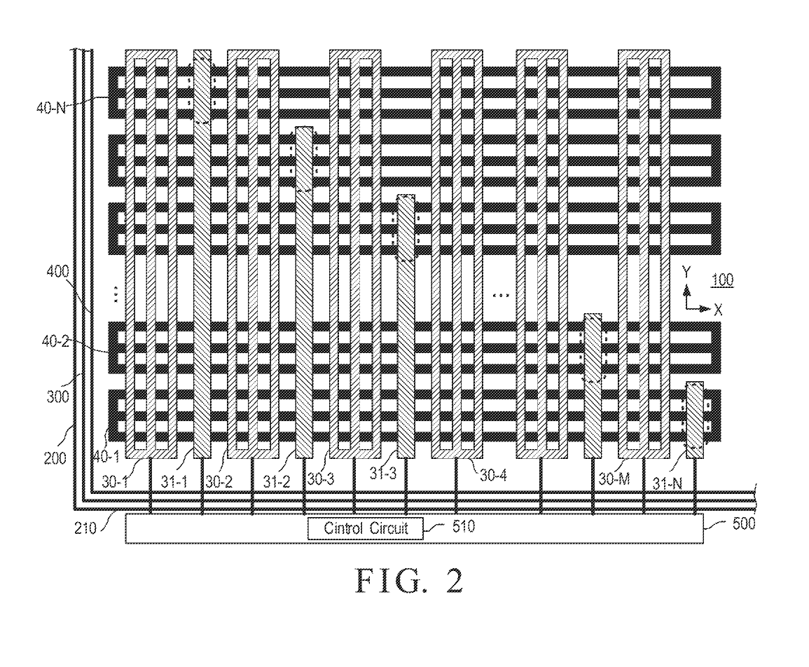

FIG. 2 is schematic diagram of a touch panel structure of narrow border 100 according to another embodiment of the invention, which is similar to FIG. 1 except that the N connection lines 31-1, 31-2, . . . , 31-N have different lengths. As shown, the lengths of the N connection lines 31-1, 31-2, . . . , 31-N are gradually decreased in this embodiment.

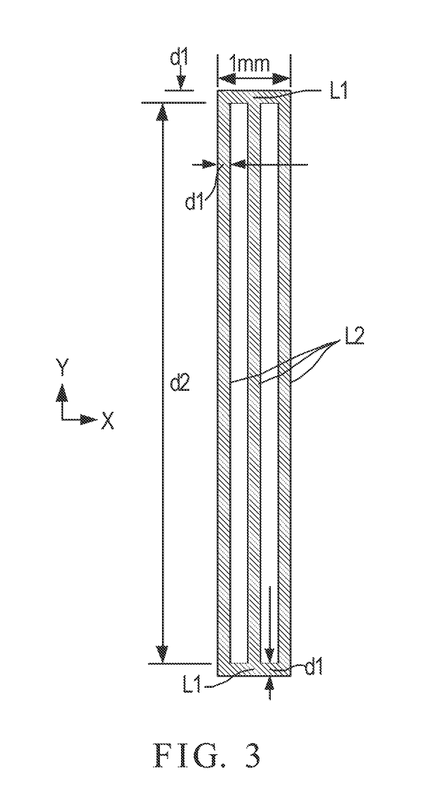

FIG. 3 is a schematic diagram of a first conductor line unit (30-1, 30-2, . . . , 30-M). As shown, the quadrilateral region is a rectangle composed of three metal sensing lines L2 in the first direction and two metal sensing lines L1 in a second direction. In other embodiments, the number of metal sensing lines can be varied according to the actual requirement.

In practical application, the length of line L1 is about 1 mm (1000 μm). The width d1 of line L1 or L2 is about 10 μm. The length d2 of line L2 is about 50 mm to 150 mm (50000 μm to 150000 μm). Because d2 is much larger than d1 and also much larger than 1 mm, the area of the quadrilateral region is 1000×d2 μm² (=1000 μm×[2×d1+d2]μm≈1000×d2 μm²). The total area of the three metal sensing lines L2 and the two metal sensing lines L1 is 30×d2 μm²(=3×d2 μm×10 μm+2×1000 μm×10 μm=10 μm×[3×d2+2×1000]≈10 μm×3×d2). Accordingly, the averaged light penetrability of the quadrilateral region is (1000×d2−30×d2)/(1000×d2)=97%. In comparison, the averaged light penetrability for the prior electrode points formed by ITO is only 90%. Therefore, the averaged light penetrability of the present invention is much better than that of the prior art. When the touch panel structure of narrow border in accordance with the present invention is combined with a liquid crystal display panel, the brightness exhibition of the liquid crystal display panel will be better than that in prior art, or the backlight energy consumption of the liquid crystal display panel can be reduced when the brightness is kept to be the same. The analysis for the light penetrability of the second conductor line unit (40-1, 40-2, . . . , 40-N) is similar to the aforementioned analysis and thus a detailed description is deemed unnecessary.

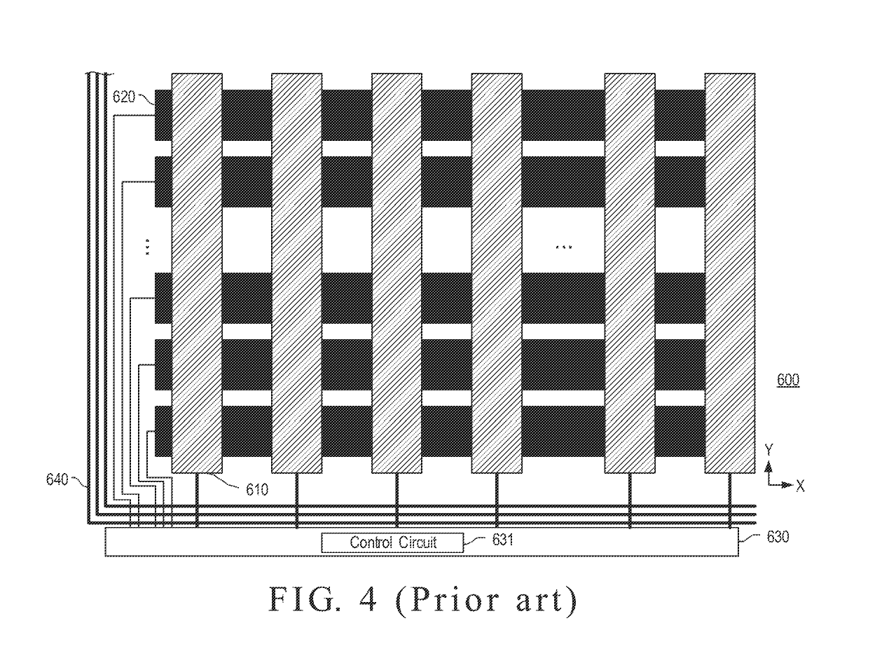

FIG. 4 is a schematic diagram of a prior touch panel structure 600. On the prior touch panel structure 600, the sensing conductor lines 610, 620 are also arranged in the first direction (Y direction)and in the second direction (X-direction). When a touch sensing is being performed and the sensing conductor lines 620 have to transmit the sensed signals to the control circuit 631 on a flexible circuit board 630, a great amount of wires at the side of the panel 640 is required for connection to the flexible circuit board 630. Such a prior design increases the border width of the touch panel and thus is not suitable for the trend of narrow border.

When the touch panel structure of narrow border in accordance with the present invention is combined with a liquid crystal display panel, the brightness exhibition of the liquid crystal display panel is better than that in prior art, or the backlight energy consumption of the liquid crystal display panel can be reduced if the brightness is kept to be the same.

Furthermore, when ITO material is used as a bridge for connecting two ITO electrode points, it is likely to have broken points or defective electrical signals at the bridges due to that the expandability of ITO material is not as good as that of metal. On the other hand, if metal is used as a bridge for connecting two ITO electrode points, it is likely to have defective electrical signals at the bridges due to that metal and ITO are heterogeneous materials, resulting in negatively affecting the accuracy of touch detection.

In the present invention, either the M first conductor line units 30-1, 30-2, . . . , 30-M, or the N second conductor line units 40-1, 40-2, . . . , 40-N, or the wires are all the same conductive metal material, so as to have better conductivity in comparison with the prior art and thus easily transmit the sensing signals of the conductor lines to the control circuit, thereby allowing the control circuit to accurately calculate the coordinates of the touch points. Moreover, the present invention has a better light penetrability in comparison with the prior art, and avoids using expensive ITO material so as to reduce the manufacturing cost. As a result, the present invention is suitable for designing a touch panel of narrow border.

Although the present invention has been explained in relation to its preferred embodiment, it is to be understood that many other possible modifications and variations can be made without departing from the spirit and scope of the invention as hereinafter claimed.

What is claimed is:

1. A touch panel structure of narrow border, comprising:
a panel having an inner surface;
a first sensing electrode layer formed on the inner surface and including M first conductor line units and N connection lines arranged in a first direction for detecting whether there is an external object approached according to a touch driving signal, where M and N are each a positive integer; and
a second sensing electrode layer formed on the inner surface and includes N second conductor line units arranged in a second direction, wherein, when performing a touch sensing and receiving the touch driving signal, each of the N second conductor line units makes use of a corresponding i-th connection line to be extended to one side of the panel, where i is an integer and 1≦i≦N

2. The touch panel structure of narrow border as claimed in claim 1, wherein each of the M first conductor line units is extended to the same side of the panel through a corresponding metal wire for being further connected to a flexible circuit board.

3. The touch panel structure of narrow border as claimed in claim 2, wherein the N connection lines are made of conductive metal material.

4. The touch panel structure of narrow border as claimed in claim 3, wherein each of the M first conductor line units is composed of plural metal sensing lines, and each of the N second conductor line units is composed of plural metal sensing lines.

5. The touch panel structure of narrow border as claimed in claim 4, wherein the plural metal sensing lines of each of the M first conductor line units form a quadrilateral region, and the plural metal sensing lines of each of the N second conductor line units form a quadrilateral region, such that the metal sensing lines in each quadrilateral region are electrically connected together, while any two of the quadrilateral regions are not connected with each other.

6. The touch panel structure of narrow border as claimed in claim 5, wherein the first direction is vertical with the second direction.

7. The touch panel structure of narrow border as claimed in claim 6, wherein each of the N connection lines is disposed between two first conductor line units.

8. The touch panel structure of narrow border as claimed in claim 7, wherein the quadrilateral region has a shape of rectangle or square.

9. The touch panel structure of narrow border as claimed in claim 8, wherein the metal sensing lines in each quadrilateral region formed by the plural metal sensing lines of each of the M first conductor line units and the N second conductor line units are made of conductive metal material or alloy material.

10. The touch panel structure of narrow border as claimed in claim 9, wherein the conductive metal material is selectively to be chromium, barium, aluminum, silver, copper, titanium, nickel, tantalum, cobalt, tungsten, or alloy or silicide.

11. The touch panel structure of narrow border as claimed in claim 10, the panel has a surface for receiving at least one touch point.

12. The touch panel structure of narrow border as claimed in claim 11, further comprising a control circuit electrically connected to the M first conductor line units and the N second conductor line units via the flexible circuit board.
